(19) United States
(12) Patent Application Publication
(10) Pub. No.: US 2009/0070144 A1
(43) Pub. Date: Mar. 12, 2009

(54) Method and system for stroke prevention and care

(76) Inventor: Sultan Haider, Erlangen (DE)

Correspondence Address: BRINKS HOFER GILSON & LIONE, P.O. BOX 10395, CHICAGO, IL, 60610, US

(21) Appl. No.: 11/978,750

(22) Filed: Oct. 29, 2007

Related U.S. Application Data
(60) Provisional application No. 60/993,159, filed on Sep. 10, 2007.

(51) Int. Cl. G06Q 50/00

(52) U.S. Cl. 705/3

(57) ABSTRACT

A system and method for evaluating patient risk factors and managing the care of patients with risk factors for neurological syndromes is described. A form-based data entry device is used to retrieve medical history data of a patient, to enter updated data, and to request further medical tests and studies. A rule-based analysis engine is used to process the data so as to permit a user to interact with the system so as to determine a suitable care path for either long-term or acute situations. The rule-based engine may be modified to reflect the capabilities and diagnostic equipment suite available at a specific medical facility, and to implement a version of an approved medical protocol consistent with the local constraints. Some of all of the form-based data may be entered by emergency personnel while the patient is in transit to the treatment facility.

This application claims the benefit of U.S. Provisional application Ser. No. 60/933,159, filed on Sep. 10, 2007, which is incorporated herein by reference.

### TECHNICAL FIELD

The present application relates to a method and system of improving patient care by assisting in the prevention of stroke and the diagnosis and care of neurological syndromes.

### BACKGROUND

Stroke is a medical emergency and can cause permanent neurological damage or death if not promptly diagnosed and treated. Many patients with stroke symptoms are examined by emergency room doctors who have difficulty deciding whether the patient is actually having a stroke, a blockage or rupture of a blood vessel in the brain that injures or kills brain cells, or is suffering from another condition, some of which present with a similar constellation of symptoms.

Strokes may be one of several types, including ischemic stroke (cerebrovascular accident (CVA)), which the most common, occurring in about 80 percent of the cases, where a blood vessel is occluded and the blood supply to a part of the brain is blocked. This type of stroke may also be categorized as a thrombotic stroke, an embolic stroke or as systematic hypoperfusion. Hemorrhagic strokes, which may also be categorized as intracerebral hemorrhage or subarachnoid hemorrhage, are caused by bleeding in the brain tissue or into the cerebrospinal fluid surrounding the brain.

In all of these situations, the brain tissue is not supplied with enough blood, and even a few minutes without a good blood supply can be disastrous. The stroke results in a sudden loss of neuronal function. Brain cells die or are seriously damaged, impairing local brain function. The symptoms of stroke usually arise quickly and can be very severe. A system and method of diagnosing the type of stroke in a clinical setting has been disclosed in U.S. provisional patent application 60/993,135, filed on Sep. 10, 2007, entitled “Method and System for Differential Diagnosis Neuro Solution, by the present inventor, which is commonly assigned, and which is incorporated herein by reference.

Prevention of strokes, the prompt diagnosis and treatment of strokes, and after-incident care are elements of a stroke mitigation process.

### BRIEF SUMMARY

A method of determining appropriate care paths for long term or acute treatment of a patient with neurological risk factors or symptoms is disclosed, the method including providing a plurality of computer-displayable data forms, at least one of which provides for a selection of multiple responses to each of a plurality of pre-determined questions. A link to a data base of the patient historical data may be provided and data that is available for the patient is retrieved. Data may requested from the patient history, or data therefrom that is relevant to the present situation may be spontaneously displayed. Additional studies may be requested and the results may be displayed by forms. A rule-based engine processes responses entered on the forms, and may also process data from the data base, and requested medical tests so as to provide at least a recommended care path. The rule-based engine may be adapted to conform to the existing diagnostic procedures and capabilities at a local medical facility.

In another aspect, a data processing system for managing the care path for patient having neurological risk factors or symptoms is described, the system including a data processor. The data processor is operable to maintain a form-based data entry system, and a rule-based process for processing data entered on the forms or retrieved from a patient medical history data base. Medical tests may be requested or test data reviewed using the forms. The data may be processed and using a rule-based engine to determine a care path, where the care path may be at least one of a long-term care path or an acute care path. The rule-based engine may be adapted to conform to the diagnostic procedures and decision criteria of a local medical facility.

In yet another aspect, a computer-readable medium having instructions executable on a computer stored thereon is described. The instructions cause a computer system to store and maintain a form-based data entry procedure, and to access at least one of a patient history data base, and a care plan protocol. Data input to the form is accepted and patient history data may be retrieved. Medical tests may be requested and the resultant data viewed in a form. The data may be processed using a rule-based engine and a care path consistent with the data is computed. The rule-based engine may be adapted to conform to the diagnostic procedures and decision criteria of a local medical facility.

### BRIEF DESCRIPTION OF THE DRAWINGS

FIG. 1 illustrates a system architecture for performing the method managing patients with neurological symptoms or risk factors;

FIG. 2 is an example of a top level questionnaire form and results form;

FIG. 3 is an example of a questionnaire form including the National Institutes of Health Stroke Score (NIHSS);

FIG. 4 is an example of a questionnaire form for collecting or displaying information regarding neurological symptoms;

FIG. 5 is an example of a questionnaire form for additional neurological and sonographic data;

FIG. 6 is an output form for presenting data of an opthalmologic examination;

FIG. 7 is an output form for presenting data of a cardiologic examination;

FIG. 8 is an output form presenting data for radiological studies using several modalities; and

FIG. 9 is an example of the use of the forms to summarize relevant diagnostic data so as to recommend a care path.

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. In other instances, well known process operations have not been described in detail in order not to unnecessarily obscure the description.

The embodiments described herein include methods, processes, apparatuses, instructions, systems, or business concepts for diagnosing patients presenting with one or more symptoms which may be indicative of a stroke. However, the examples of diseases, syndromes, conditions, and the like, and the types of examination, diagnosis and treatment protocols described herein are by way of example, and are not meant to suggest that the method and system is limited to those named, or the equivalents thereof. As the medical arts are continually advancing, the use of the methods and system described herein may be expected to encompass a broader scope in optimizing the diagnosis and treatment of patients.

The combination of hardware and software to accomplish the tasks described herein is termed a system. Where otherwise not specifically defined, acronyms are given their ordinary meaning in the art.

The instructions for implementing processes or methods of the system, may be provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In an embodiment, the instructions may be stored on a removable media device for reading by local or remote systems. In other embodiments, the instructions may be stored in a remote location for transfer through a computer network, a local or wide area network or over telephone lines. In yet other embodiments, the instructions are stored within a given computer or system.

The instructions may be a computer program product, stored or distributed on computer readable media, containing some or all of the instructions to be executed on a computer to perform all or a portion of the method or the operation of the system.

Medical data systems and medical procedures may be used collect information on patients, including medical history, demographic information, results of medical tests, prior treatment, including specific worksteps and outcomes, and other information related to individual patients. Generally, the course of treatment, or care path, for a patient may be based an electronic formula or other algorithm, which may be deterministic or probabilistic, with the detailed course of treatment based on the symptoms, tests and patient response to treatment. The course of treatment may be termed a “care path” or a “care plan”. Each medical facility may have different suites of treatment and diagnostic equipments, and constraints on the use thereof due to scheduling conflicts.

As advanced methods for self-learning and prediction, the system could use artificial neural networks, genetic algorithms, Bayesian methods, estimation theory, fuzzy logic, or the like. The system may learn about the user preferences for performing certain examination procedures and optimize the user interface accordingly. The system might offer default protocols for performing examinations according to optimized care paths.

The present embodiments may provide a system/software program product operable to accept data from a form-based input device, and to retrieve data from a data base having a medical history of the patient. The software application may include a user interface that implements access rights or other security measures. The user interface may provide user at one facility with access to data associated with the patient and the care plan collected at other facilities.

A stoke prevention and mitigation plan may include elements that relate to following a patient prior to and during a stroke incident, and subsequent to the stroke. Currently, patient health records may not be systematically stored in a data base for convenient retrieval. The information may be unstructured with respect to particular syndromes and include a substantial amount of non-relevant information. The data may not be in chronological order, or the results of a series of medical laboratory tests may not be organized in a form for convenient review, such as by graphical display. Yet, this is what a physician may need when presented with an emergency. Even in routine care, the quality of the information being presented is a factor in providing effective care. In addition to access to information, a physician may find that a particular organization of the data presented may be more effective in the practice of medicine, and flexibility in such presentation would be useful.

The method may include a personalized risk assessment for the individual patient. For prevention of a first stroke, or a re-occurrence of stroke, data such as blood values, blood lipids, medication, blood glucose, blood pressure, smoking and other behavioral aspects of the patient may be monitored and analyzed. The availability of such data for a patient both facilitates diagnosis of a patient arriving in an emergency room with symptoms of stroke, and assists medical personnel in recommending and providing immediate and long term care.

In an aspect, the system and method may include using a form based entry of symptoms, and related medical data and diagnoses, a rule-based engine, an interface with a care plan implementation system, a data base, and input and output mechanisms. The diagnosis method may be implemented and programmed in an electronic formula or other algorithm. The fields in the formula may be linked to a database, either remote or local, such as a Microsoft SQL-database with a SQL (Structured Query Language) server. Other databases may be used. The system may be operable to add, delete, and/or select data (such as text and/or images) from data files. The system may offer a search mechanism, such as a search engine, operable to search remote databases. For instance, medical personnel at one facility may be able to remotely search a database stored at another facility involved with the performance of the diagnosis and subsequent care plan to gather information about the patient, tests and diagnoses which may be related to the present syndrome and which have previously been performed performed, and other information regarding the patient, including patient characteristics and other healthcare data provided to the patient and which may be unrelated to the care plan (such as medications previously or currently prescribed for the patient and past illnesses treated).

In an aspect, a risk profile for a patient may be prepared and maintained. By analyzing the patient medical history and current medical laboratory test results, the individual patient prognosis for developing a stroke may be assessed. As further data for a patient are obtained, through examinations, tests, studies, and the like, they may be added to the data base. To the extent that the data may be subject to statistical analysis, various metabolic data may be analyzed to determine the temporal trends, response to medications, and the like. Where the data is usable in other care plans, such as for cardiovascular, mammography, and the like, the data may be shared between the care plans through the data base.

In another aspect, data may be provided to the data base through telemonitoring of a patient, either in a clinical setting, or as an outpatient. Such data may include blood pressure, heart rate, and other metabolic data that may be monitored, depending on the equipment available. As the medical arts evolve, more and more metabolic data types may be remotely monitored. The data may be analyzed to provide an alert for changes which may be indicative of a stroke, or other significant metabolic change that ought to be investigated.

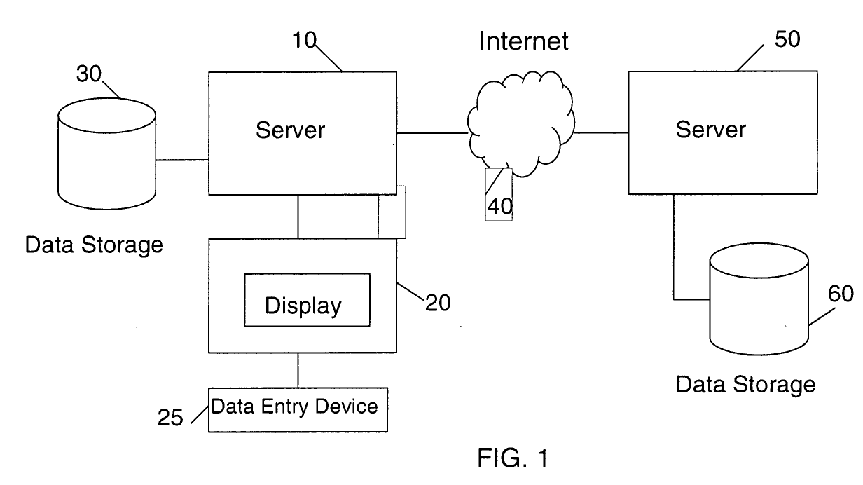

FIG. 1 is an example of a computing system architecture which may be suitable for executing the software programs and managing the data bases associated with the diagnosis and care processes. A server or computer 10 may execute a software product so as to exhibit the functionality described herein, where the server is a computing device having a central processor unit (CPU), memory and interfaces, as is known in the art, and an attached memory system which may be semiconductor memory, a rotating disk 30, magnetic tape, or a combination thereof. Such memories may be local to the server 10, and be connected through interfaces or a local area network (LAN).

In an aspect, the data may be located at another facility and accessed through a wide area network (WAN), which may be the Internet 40, or other telecommunication system. Typically, at least portions of the WAN are provided by others, and the LAN may be an existing shared resource at the local medical facility. The remotely located data base may be stored on a disk 60, or other non-volatile or backed-up volatile memory attached to a server 50 having an interface to the WAN.

Forms may be displayed on a display unit 20, which may be located in the emergency room, an ambulance, or other location convenient to the professional responding with the information solicited by the form. The information may be entered through a keyboard 25, keypad, touch screen, or by voice recognition, depending on the location of the data entry device.

In an aspect, data may also be entered remotely, for example, by a diagnostic lab, or by radiology equipment using standard data interface protocols such as DICOM (Digital Communications in Medicine), or may be entered autonomously by telemonitoring equipment which may be attached to the patient. The data may be entered through a telecommunications network, and the data path may include wireless portions.

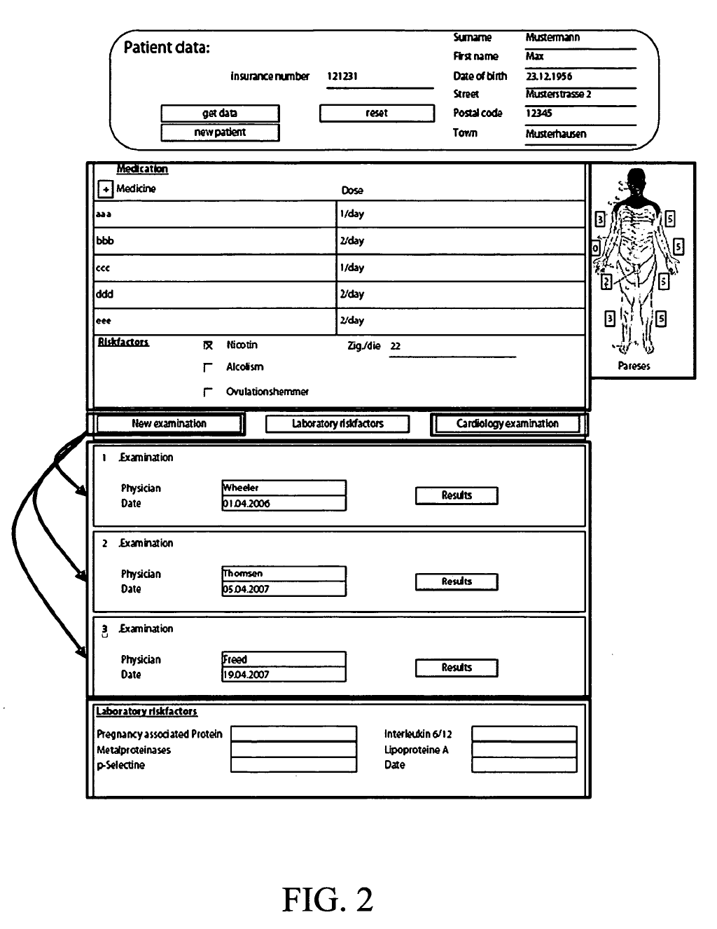

FIGS. 2-8 show examples from a series of questionnaire-based data collection and data display forms. The forms both display data already collected, and serve to order further tests and studies of the patient. These examples are intended to suggest the types of forms that may be developed and used to organize and present data from a patient health information data base, and to manage the diagnosis and care of a patient, both in a medical facility or on an outpatient basis. As such, the forms are illustrative and not intended to limit the scope and functionality of a system of this type. The forms may be adapted to the medical practice in a region, a hospital, or the like, so as to reflect both differences in medical practice, and the availability of diagnostic and testing equipment.

The forms may provide a portion of the input data to facilitate the use of a rule-based diagnosis engine. The rule-based engine may have deterministic or probabilistic characteristics, and contain heuristic decision rules based on a “best practices” diagnosis procedure. The procedure may have been adapted to local needs, as the personnel and diagnostic equipment suite may differ. Even at a specific facility, the availability of specific equipment and personnel may be time dependent.

As shown in FIG. 2, the form may be used to retrieve information regarding a patient that may be stored at the medical facility. Where a networked system is deployed, such as described in U.S. patent application Ser. No. 11/796,524, filed on Apr. 27, 2007, entitled “Service Module in Clinical Workflow Simulation Tool for Healthcare Institutions”, which is commonly owned and which is incorporated herein by reference, the stored information may be accessed where permitted and as relevant to the present situation. This may be done, for example, by entering the patient's name, an insurance or other identifying number, date of birth, or the like, in the patient data portion of the form. Not all of the fields of the form may need to be completed in order to access a patient record.

Access to the patient data may be controlled by password or other means, including biometric data, as is known in the art, or may later be developed. In this example, the person accessing the forms displayed is presumed to have already completed the process of self-identification to the system for the purposes of gaining access to the information displayed. Depending on the access privileges of the individual, more or less than the information shown in the example may be displayed. The ability to order further examinations, to modify records, and the like, may also depend on the level of access privileges, and the nature of the symptoms being evaluated or treated.

A form, such as shown in FIG. 2, may display information on the medication currently being administered to the patient, the extent and location of the actual observed pareses (paralysis), and known risk factors for neurological problems. The medical professional may then access pervious examination results or request new examinations by pressing the “New Examination” button, and a summary of previous examinations may be displayed. Here, three previous examinations have been displayed. Pressing the “Results” button may cause another form to be displayed with the results of the examination selected. In this example, the Laboratory Risk Factors are also displayed on the form.

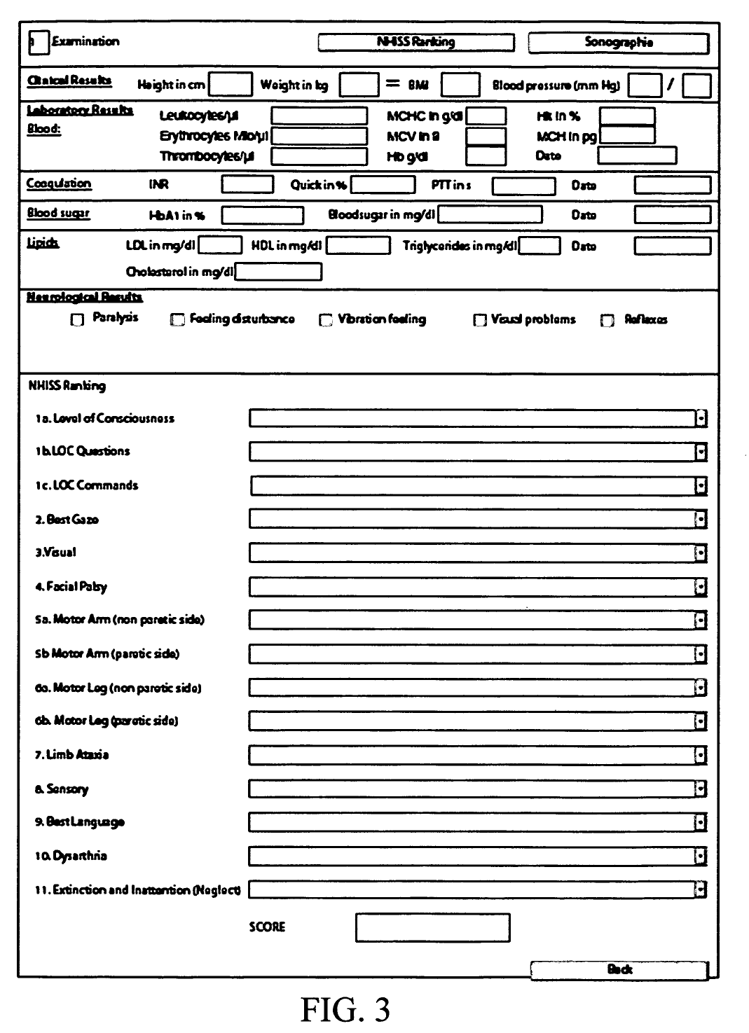

The lower half of FIG. 3 is an example of a form that may be used for a standardized assessment of neurological function. This particular form is well known as the NIHSS (National Institutes of Health Stroke Score), and is used in a similar form in many areas of the world. The protocol consists of a series of questions to be answered by the person testing the patient. The answers may be presented to the user in the form of a drop-down menu. Generally the answers are ranked on a scale of 0-3 or 4, and L (left) or R (right) where there may be an asymmetrical response. In a few instances, the characteristic may not be observable and an X may be entered. The sum of the responses gives a numerical assessment of the severity of the symptoms of a stroke, with the higher numbers representing more severe symptoms. This test may be repeated numerous times during a stroke incident as a way of objectively reporting the condition of the patient. As such, as series of NIHSS scores may be a part of the patient health record.

The patient history accessed may be recent or historical, depending on the situation. To the extent that information can be obtained from the patient or other person, the questionnaires may be completed. This approach is structured so as to obtain information in a simple form that is associated with the diagnostic process. In this example, much of the information may be entered through drop-down boxes; however, radio buttons, check boxes and the like are similarly useful.

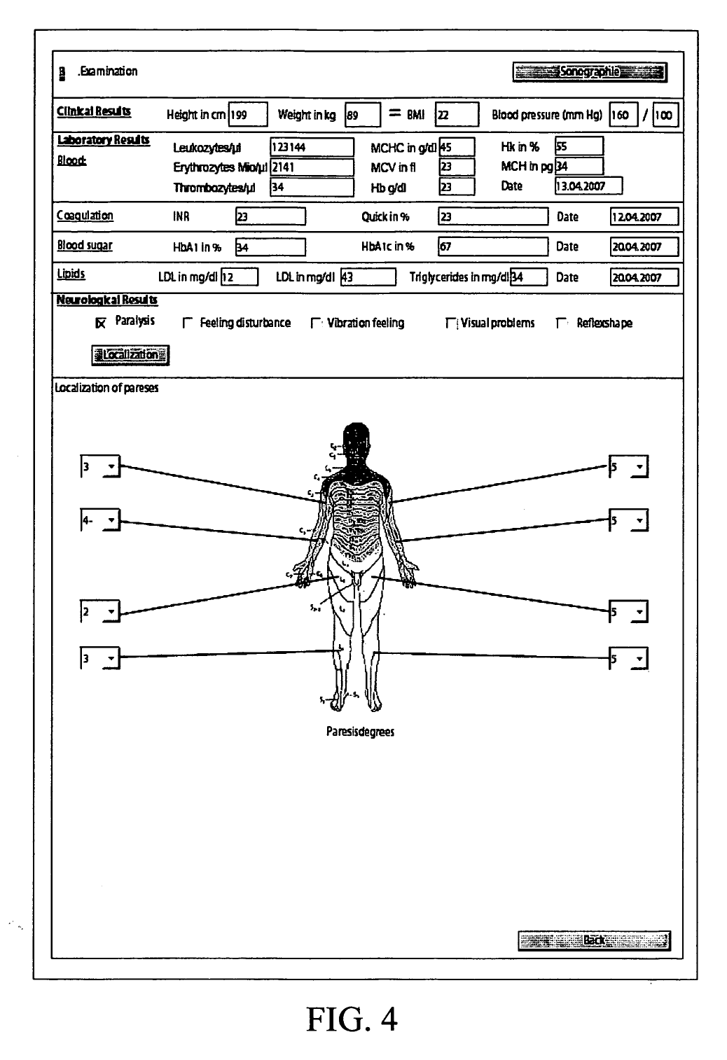

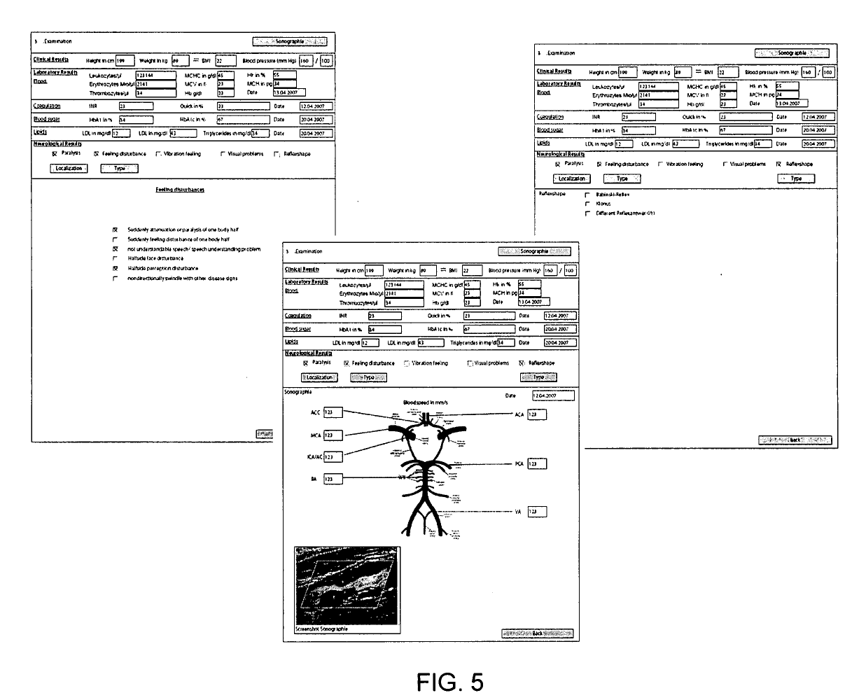

In another form, more detailed examination results may be either entered or presented. For example, as shown in FIG. 4, the questionnaire may be related to determining the location and severity of the paralysis. By selecting “Paralysis”, a button for “Localization” may be displayed, and selecting the button may display a representation of the human anatomy, annotated with regions that are significant in the assessment of paralysis. For each of the regions, the user may enter numerical values representing a scale of paralysis of the regions. Other examples of forms that may be selected are shown in FIG. 5, for “Feeling Disturbances”, “Reflexes”, and for “Sonographic” studies. Each of the forms may be linked to subsidiary forms that may be developed or are in use to obtain the data in a standardized form so that the patient data maybe stored and analyzed using a rules-based engine.

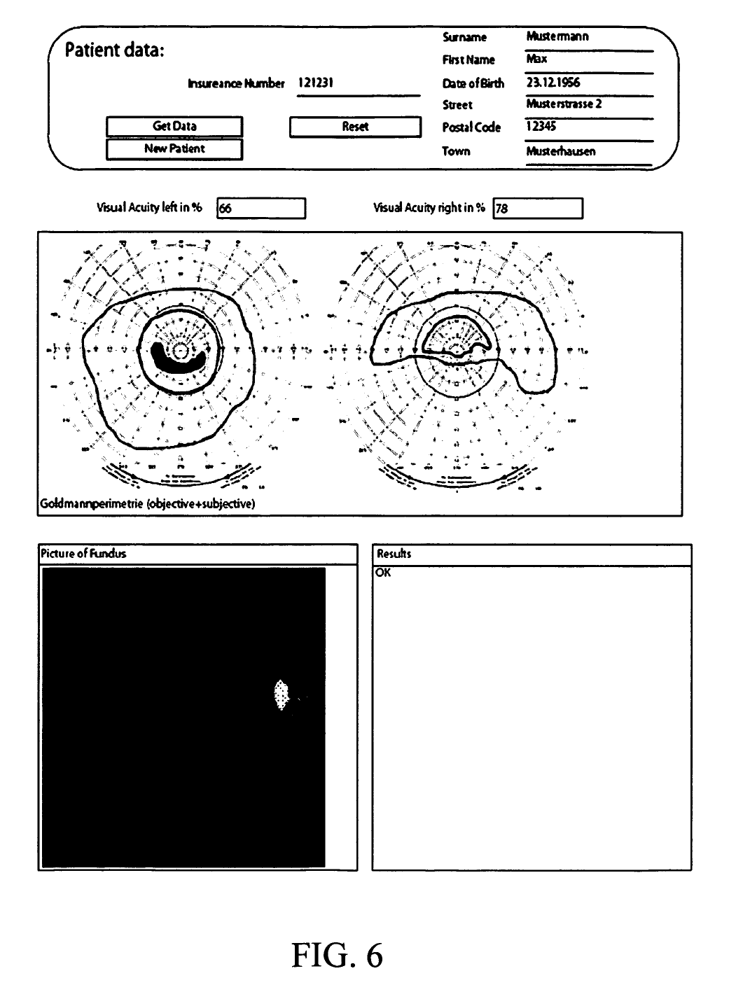

FIG. 6 is an example of a form which may be used to summarize and present data from an opthalmological examination of the patient, and may include images, such as may be obtained of the fundus. The fundus is the interior surface of the eye, including the retina, optic disc, macula, and posterior pole. The fundus can be viewed with an opthalmoscope. Other data, such as visual acuity in each eye and a quantitative assessment of acuity such as a Goldmann Perimeter may also be performed and displayed. Other types of acuity testing, which may include one of several automated techniques such as Humphrey, Topcon, Octopus, or Dicon, or an Amsler screen may be used, depending on the situation. A text box may also be provided so that the specialist may summarize any findings for the record and for further use in diagnosis or treatment.

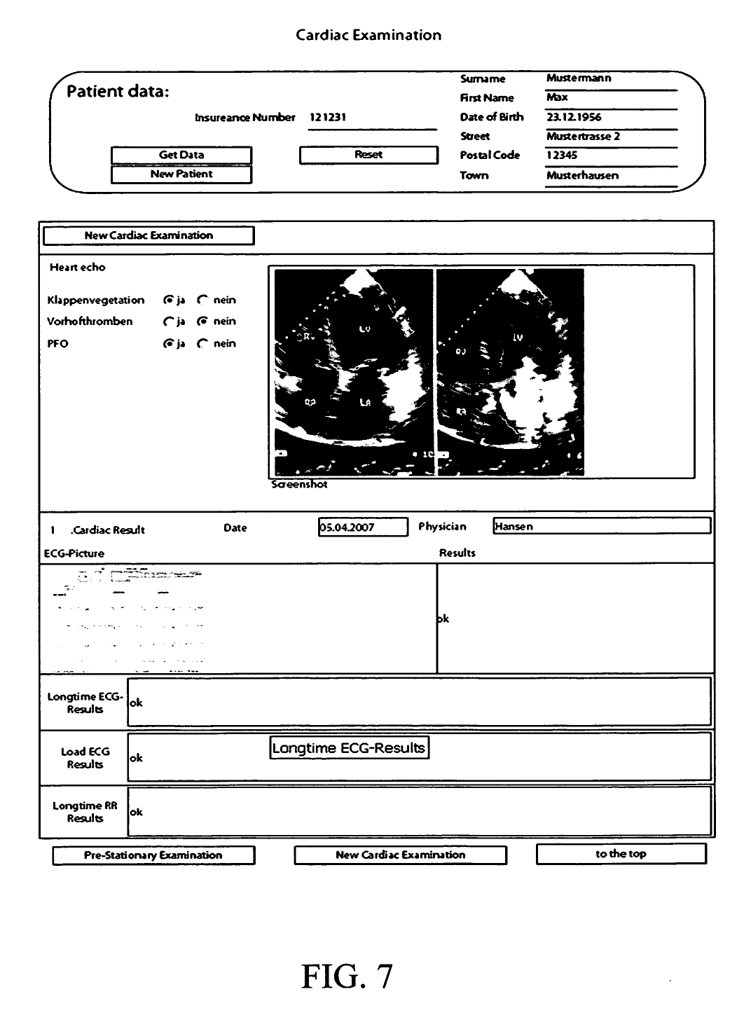

FIG. 7 shows a cardiac results form, which may provide further diagnostic data. In this example of a form, images from a heart echocardiogram may be displayed. Such images are often time varying so as to show the velocity of blood flow measured by Doppler techniques. In addition, heart function as measured by electrocardiogram (ECG) may be displayed. Both recent and historical data are valuable in making a diagnosis. Other sonographic studies may be performed and presented in a form such as investigation of the carotid artery.

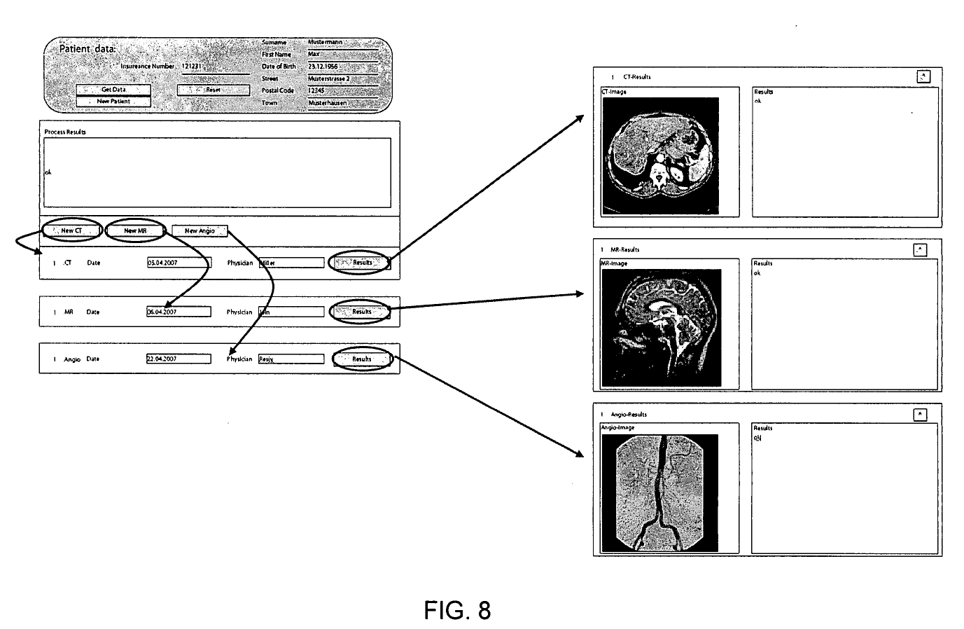

Similarly, FIG. 8 shows that radiographic studies may be presented. Each completed study may be first viewed in summary form and by type body region, and the user may select an appropriate study by pressing the results button. This will recall the results of the study, which may be presented in a format such as shown in the right-hand-side of the figure, and include both images, and a word summary of the specialist's evaluation of the data. In this example, radiological studies of the head included computerized tomography (CT), magnetic resonance imaging (MRI), and an X-ray angiogram.

The results of the various questionnaires, only examples of which have been shown, produce raw and analyzed data describing the patient from a medical viewpoint. The data may be quantitative or verbal in nature, where the observational data are coded in a form suitable for processing by a rules-based engine. Thus, in addition to the medical professional's judgment based on experience, an objective assessment of the patient may be performed based on established medical protocols for the medical institution, taking account of the types of diagnostic data that are available.

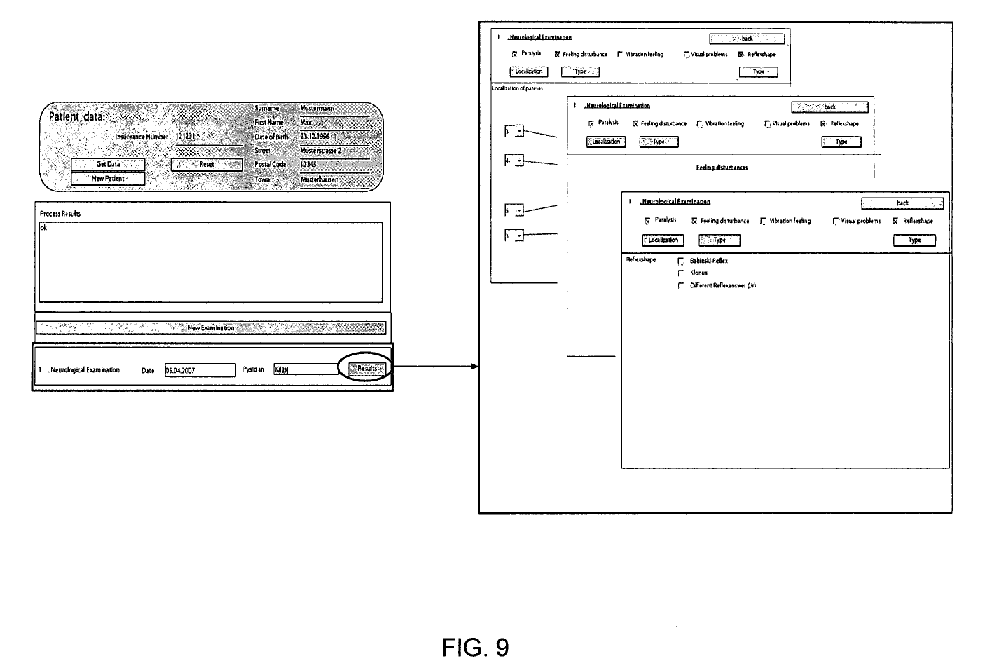

When sufficient studies have been performed, the user may review the studies as shown in FIG. 9, and the results of the rule-based engine analysis. Other studies may be ordered, or the user may decide to accept or modify a recommended care plan.

The description of the system and method herein has proceeded somewhat linearly through a group of studies and data for the purposes of exposition. Depending on the available data and the currency of the data, some studies may not need to be performed, while others may need to be performed again as the situation can have been expected to change. Multiple versions of the same study may performed at different times in the clinical history of the patient, so as to make an initial diagnosis and decide on a suitable care plan, and to assess the progress of the patient and determine if alterations to the care plan are warranted.

The use of this data is not limited to acute situations, but may be equally useful over a period of time to monitor the patient and associated risk factors, adjust medicine types and doses, provide advice and guidance to the patient, and the like. By keeping a medical history data base up-to-date, the assessment of acute conditions may be expedited, and this is particularly crucial in instances of stroke, where rapid intervention may be needed.

While the description has been in terms of the data gathering and data input by personnel in a facility, certain data may be obtained and input by, for example, emergency medical technicians (EMT) who are accompanying the patient to the hospital or other treatment facility in an ambulance or emergency vehicle. The vehicle may be in radio contact by voice or data with the treatment facility, and be able to access patient medical information, or at least complete portions of a questionnaire, such as the NIHSS, in transit. As such, the emergency room personnel may already have the results shown in FIG. 3, and may be better able to schedule any further diagnostic or confirmatory tests needed by the care plan protocol.

An example of a method of managing the care of a patient having neurological risk factors or symptoms has been described; this approach may be adapted to a specific facility, and evolve with time as medical knowledge advances.

The methods disclosed herein have been described and shown with reference to particular steps performed in a particular order; however, it will be understood that these steps may be combined, sub-divided, or reordered to from an equivalent method without departing from the teachings of the present invention. Accordingly, unless specifically indicated herein, the order and grouping of steps is not a limitation of the present invention.

While the preferred embodiments of the invention have been described, it should be understood that the invention is not so limited and modifications may be made without departing from the invention. The scope of the invention is defined by the appended claims, and all systems and methods and products that come within the meaning of the claims, either literally or by equivalence, are intended to be embraced therein.

What is claimed is:

1. A method of managing the care path for a neurological syndrome of a patient, the method comprising:
providing a plurality of computer-displayable data forms, at least one of which provides for a selection of multiple responses to each of a plurality of pre-determined questions;
linking the forms to a data base of the patient medical history data, and retrieving data that is available for the patient;
displaying requested data of available patient medical history;
requesting specific medical tests and studies using selectable buttons on the forms and displaying the results of the requested studies; and
providing a rule-based engine to process at least one of responses entered on the forms, results of specific medical tests, or information from the data base so as to provide at least a recommended care path,
wherein the rule-based engine is adapted to conform to the existing diagnostic and treatment procedures at a local medical facility.

2. The method of claim 1, wherein at least one of the forms is the National Institutes of Health Stroke Score (NIHSS).

3. The method of claim 2, wherein at least a portion of the information needed for the NIHSS form is entered while the patient is in transit to the local medical facility.

4. The method of claim 1, wherein results of medical procedures currently or previously performed are linked to the forms.

5. The method of claim 1, wherein the data associated with responses to the questions of the forms is stored in the patient medical history data base.

6. The method of claim 1, wherein the result of the rule-based engine analysis is a recommended long-term care plan.

7. The method of claim 1, wherein the result of the rule based engine analysis is a recommended acute care plan.

8. The method of claim 1, wherein the forms are displayed on an electronic display, and the data is entered at least in part by a keyboard device.

9. A data processing system for managing the care of patients with neurological syndromes, the system comprising:
a data processor operable to:
maintain a form-based data entry device, and a rule-based engine for analyzing data entered on the forms or retrieved from a patient medical history data base;
accept data from at least one of the form-based data entry device or the patient medical history data;
request medical tests using at least one form and display the results of the medical test on a form; and
analyze the data using the rule-based engine to recommend a care path for a patient having a neurological syndrome or risk factors for the neurological syndrome,
wherein the rule-based engine is adapted to conform to diagnostic procedures and decision criteria of a local medical facility.

10. The data processing system of claim 10, wherein the patient medical history data base is accessed through a telecommunications network.

11. The data processing system of claim 11, wherein the telecommunications network is the Internet.

12. The data base system of claim 10, wherein the data processor receives data input from the form-based data entry device, at least in part over a wireless network.

13. A computer-readable medium having instructions executable on a computer stored thereon, the instructions causing a computer system to:
store and maintain a form-based data entry procedure;
access at least one of a patient history data base, or a care plan protocol;
accept data input to a form or retrieve patient history data;
request medical tests using at least one form and present results of the medical tests on at least one form;
process at least one of the form or retrieved data using a rule-based engine; and
select a care plan for a patient having neurological risk factors or symptoms consistent with the data,
wherein the rule-based engine is adapted to conform to the diagnostic procedures and decision criteria of a local medical facility.

14. The computer readable medium of claim 14, wherein the care plan is one of a long-term prevention plan or an acute care plan.

15. The computer readable medium of claim 14, wherein the data input to the form is transmitted to the computer system at least in part over a wireless communications link.
